(19) United States
(12) Patent Application Publication
(10) Pub. No.: US 2013/0144755 A1
(43) Pub. Date: Jun. 6, 2013

(54) APPLICATION LICENSING AUTHENTICATION

(71) Applicants: David Mowatt, Dublin (IE); David Ahs, Dublin (IE); Humberto Lezama Guadarrama, Redmond, WA (US); Terry Farrell, Dublin (IE); David LeBlanc, Monroe, WA (US); Onur Cobanoglu, Kirland, WA (US); Pieter Kasselman, Dublin (IE); Goksel Gene, Belleveue, WA (US)

(72) Inventors: David Mowatt, Dublin (IE); David Ahs, Dublin (IE); Humberto Lezama Guadarrama, Redmond, WA (US); Terry Farrell, Dublin (IE); David LeBlanc, Monroe, WA (US); Onur Cobanoglu, Kirland, WA (US); Pieter Kasselman, Dublin (IE); Goksel Gene, Belleveue, WA (US)

(73) Assignee: Microsoft Corporation, Redmond, WA (US)

(21) Appl. No.: 13/308,829

(22) Filed: Dec. 1, 2011

(51) Int. Cl. G06Q 30/06

(52) U.S. Cl. 705/26.41

(57) ABSTRACT

Methods and systems for application licensing authentication are disclosed herein. The method includes processing a request for a license for an application from a purchaser at a marketplace service. The method also includes sending a token from the marketplace service to a client platform, wherein the client platform is configured to allow the purchaser to assign a seat to a user and to send the token to a third party service when the user attempts to access the application. The method further includes accepting the token from the third party service at the marketplace service, verifying the validity of the token within the marketplace service, and returning a message verifying the validity of the token to the third party service. Moreover, the third party service may be configured to allow the user to access specific levels of service within the application through the client platform.

### BACKGROUND

Electronic commerce, or e-commerce, refers to the buying and selling of products or services over electronic systems, such as, for example, the Internet or other computing networks. A marketplace is a type of e-commerce site or service in which a product or service is provided to a client via multiple third party companies. As marketplaces are becoming increasingly popular, third party companies are availing of marketplaces as a way to extend their reach and sales by letting marketplaces resell access to services or applications that might be offered by the third party company. For example, if a mapping service company wishes to sell their product, they may sell a “mapping application” in a marketplace. This application may provide a certain user experience; however, the bulk of the functionality will be powered by a back-end third party Web service. Providers of valuable services benefit from having a way to verify that, when their Web services are called, the caller is someone who has paid, as opposed to a person attempting to use the services of the site without paying.

In general, this problem is currently solved through the use of “Open Authorization” (OAuth). OAuth is an open standard for authorization through the use of tokens instead of credentials, such as, for example, the username and password of a user. In a typical scenario using OAuth, each third party Web service may register its domain with the marketplace and receive an “application secret.” When a particular user of the application or service attempts to use the particular application or service for the first time, the user may be forced to sign in to the marketplace first. At this point, the marketplace may validate the identity of the user, and a token may be generated using the application secret. The token may then be passed back to the third party Web service to be stored, often as a cookie on the user's machine.

However, a key shortcoming of the OAuth approach is that the marketplace may have to obtain the identity of the user, either directly or through federated identity. Federated identity may be used to link a user's electronic identity and attributes that may be stored across multiple distinct identity management systems. This is reasonable in consumer-focused marketplaces in which the user is the same person as the purchaser. However, it is a big hurdle for enterprise marketplaces in which the actual end user may not be the same person as the purchaser. For such enterprise marketplaces, different types of authentication models may be used to validate the marketplace users. In addition, the directors of such enterprise marketplaces may wish to centralize purchasing actions by bestowing purchasing power on a few administrators, rather than bestowing purchasing authority upon every user. Moreover, many enterprises are resistant to their entire employee-base being forced to learn a new identity in order to use applications from a marketplace. Finally, there is the technological challenge of ensuring that the particular server where the purchased application is installed can securely access and download the application from the marketplace. This may be a problem because the purchaser may be signed in on their own personal computer (PC), not on the server. Therefore, the call from the server to download the paid application from the marketplace cannot be authenticated.

### SUMMARY

The following presents a simplified summary of the innovation in order to provide a basic understanding of some aspects described herein. This summary is not an extensive overview of the claimed subject matter. It is intended to neither identify key nor critical elements of the claimed subject matter nor delineate the scope of the subject innovation. Its sole purpose is to present some concepts of the claimed subject matter in a simplified form as a prelude to the more detailed description that is presented later.

An embodiment provides a method for application licensing authentication. The method includes processing a request for a license for an application from a purchaser at a marketplace service and sending a token from the marketplace service to a client platform, wherein the client platform is configured to allow the purchaser to assign a seat to a user and to send the token to a third party service when the user attempts to access the application. The method also includes accepting the token from the third party service at the marketplace service and verifying the validity of the token within the marketplace service. The method further includes returning a message verifying the validity of the token to the third party service, wherein the third party service is configured to allow the user to access specific levels of service within the application through the client platform.

Another embodiment provides a system for application licensing authentication within a marketplace environment. The system includes a marketplace service configured to accept a request for a license for an application within a client platform from a purchaser and send a token from the marketplace service to the client platform, wherein the client platform is configured to allow the purchaser to assign a seat to a user and to send the token to a third party service when the user attempts to access the application. The marketplace service is also configured to accept the token from the third party service, verify the validity of the token, and return a message verifying the validity of the token to the third party service, wherein the third party service is configured to allow the user to access services within the application through the client platform.

Another embodiment provides one or more non-volatile computer-readable storage media for storing computer readable instructions, the computer-readable instructions providing an application licensing authentication system when executed by one or more processing devices. The computer-readable instructions include code configured to process a request for a license for an application from a purchaser at a marketplace service and send a token from the marketplace service to a client platform, wherein the client platform is configured to allow the purchaser to assign a seat to a user and to send the token to a third party service when the user attempts to access the application. The computer-readable instructions also include code configured to accept the token from the third party service, verify a validity of the token, and send a message verifying the validity of the token to the third party service, wherein the third party service is configured to allow the user to access different levels of service within the application.

This Summary is provided to introduce a selection of concepts in a simplified form; these concepts are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is an embodiment of a system for application licensing authentication within a marketplace environment;

FIG. 2 is a block diagram of a method for application licensing authentication;

FIGS. 3A and 3B are an embodiment of a message flow diagram for application licensing authentication in which the user does not have to sign in to the marketplace service in order to utilize the application;

FIGS. 4A and 4B are an embodiment of a message flow diagram for application licensing in which the purchaser is also the user; and

FIG. 5 is a block diagram showing a tangible, computer-readable medium that stores code adapted to authenticate a license for an application that is powered by a third party service.

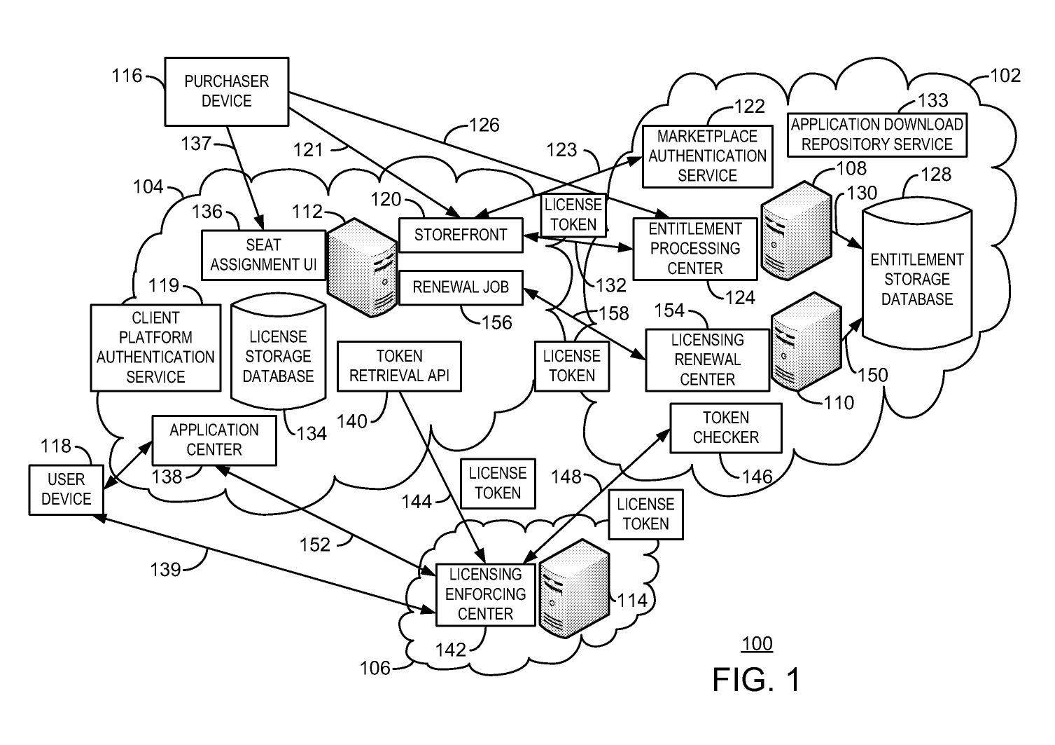

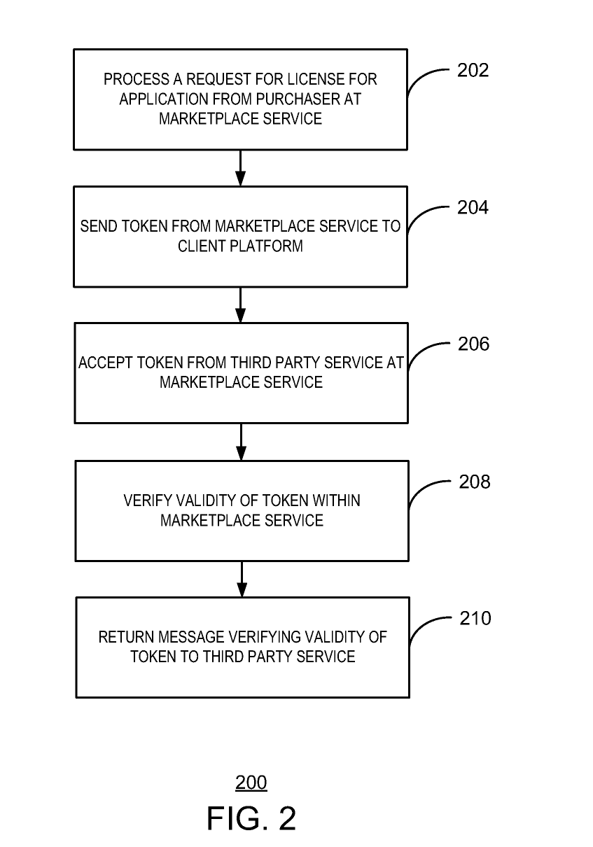

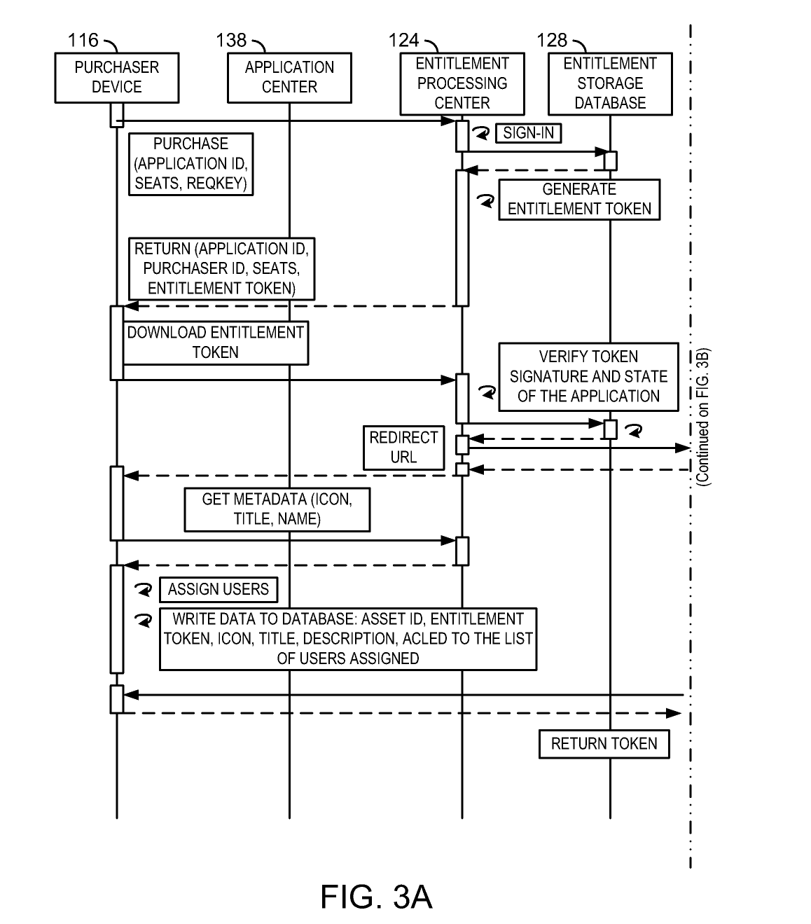

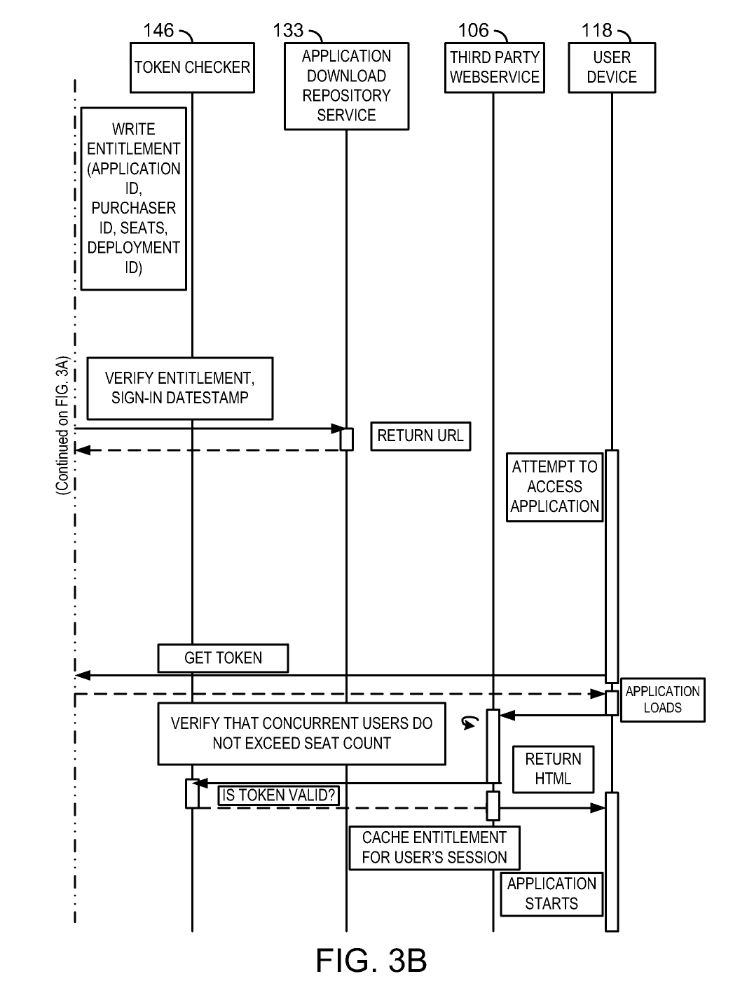

The same numbers are used throughout the disclosure and figures to reference like components and features. Numbers in the 100 series refer to features originally found in FIG. 1, numbers in the 200 series refer to features originally found in FIG. 2, numbers in the 300 series refer to features originally found in FIG. 3, and so on.

### DETAILED DESCRIPTION

Embodiments disclosed herein set forth a method and system for application licensing authentication. As used herein, the term “application” may refer to any type of application or service that is provided by a third party service, or any type of content with restricted access rights. The method and system may reduce the burden on a user of an application within a marketplace environment by allowing a user to access the application without having to log in directly to the marketplace. This is performed by a method and system that allow for effective differentiation between the authentication of the identity of the purchaser of an application and the authentication of the identity of the actual end user of the application. In some embodiments, the user may not be the same as the purchaser, since the purchaser may purchase a specific amount of “seats,” wherein the specific amount of seats is the number of users who may access the application or service under the purchased license. In some embodiments, a purchaser may buy a service or application on behalf of a user and may transfer the entitlement to the user. For example, a purchaser may transfer the entitlement for a particular application or service to a user as a gift. Moreover, in some embodiments, the application that is run by the user's computing device may be different from the application that was run by the purchaser's computing device during the purchasing process. This may occur, for example, if a license authorizes access to multiple applications. Furthermore, the method and system disclosed herein may also minimize the risk of piracy occurring through a third party Web service. In some embodiments, the risk of piracy may be minimized by providing a specific token to the user attempting to access an application and ensuring that the token is verified before the user is allowed to access the application.

In embodiments, a marketplace service may act as a license authority. The marketplace service can process payments received from a purchaser, provide tokens to a purchaser, verify the validity of received tokens, send updated tokens to the purchaser at specified time intervals, and verify and renew licenses. In various embodiments, the tokens may act as proof of having particular licenses and may be used to validate an identity of a user attempting to access one or more specific applications. Further, the license may include a right to access and use a particular application for a specified amount of time, or may include a right to access different sets of features within the application. The application may be any type of service that is offered to a user, or client, through a client platform. The application may be provided to the client platform by a third party service within a marketplace environment.

As a preliminary matter, some of the figures describe concepts in the context of one or more structural components, variously referred to as functionality, modules, features, elements, etc. The various components shown in the figures can be implemented in any manner, for example, by software, hardware (e.g., discreet logic components, etc.), firmware, and so on, or any combination of these implementations. In one embodiment, the various components may reflect the use of corresponding components in an actual implementation. In other embodiments, any single component illustrated in the figures may be implemented by a number of actual components. The depiction of any two or more separate components in the figures may reflect different functions performed by a single actual component. FIG. 1 provides details regarding one system that may be used to implement the functions shown in the figures.

Other figures describe the concepts in flowchart form. In this form, certain operations are described as constituting distinct blocks performed in a certain order. Such implementations are exemplary and non-limiting. Certain blocks described herein can be grouped together and performed in a single operation, certain blocks can be broken apart into plural component blocks, and certain blocks can be performed in an order that differs from that which is illustrated herein, including a parallel manner of performing the blocks. The blocks shown in the flowcharts can be implemented by software, hardware, firmware, manual processing, and the like, or any combination of these implementations. As used herein, hardware may include computer systems, discreet logic components, such as application specific integrated circuits (ASICs), and the like, as well as any combinations thereof.

As to terminology, the phrase “configured to” encompasses any way that any kind of functionality can be constructed to perform an identified operation. The functionality can be configured to perform an operation using, for instance, software, hardware, firmware and the like, or any combinations thereof.

The term “logic” encompasses any functionality for performing a task. For instance, each operation illustrated in the flowcharts corresponds to logic for performing that operation. An operation can be performed using, for instance, software, hardware, firmware, etc., or any combinations thereof.

As utilized herein, terms “component,” “system,” “client” and the like are intended to refer to a computer-related entity, either hardware, software (e.g., in execution), and/or firmware, or a combination thereof. For example, a component can be a process running on a processor, an object, an executable, a program, a function, a library, a subroutine, and/or a computer or a combination of software and hardware.

By way of illustration, both an application running on a server and the server can be a component. One or more components can reside within a process and a component can be localized on one computer and/or distributed between two or more computers. The term “processor” is generally understood to refer to a hardware component, such as a processing unit of a computer system.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any non-transitory computer-readable device, or media.

Non-transitory computer-readable storage media can include but are not limited to magnetic storage devices (e.g., hard disk, floppy disk, and magnetic strips, among others), optical disks (e.g., compact disk (CD), and digital versatile disk (DVD), among others), smart cards, and flash memory devices (e.g., card, stick, and key drive, among others). In contrast, computer-readable media generally (i.e., not necessarily storage media) may additionally include communication media such as transmission media for wireless signals and the like.

FIG. 1 is an embodiment of a system 100 for application licensing authentication within a marketplace environment. The system 100 may include a marketplace service 102, a client platform 104, and a third party service 106. As shown in FIG. 1, the marketplace service 102, the client platform 104, and the third party service 106 may include servers 108 and 110, 112, and 114, respectively. Moreover, the third party service 106 may also be an application center that is configured to directly control access to services offered by a particular application.

However, the number of servers is not limited to those shown in this example. In a cloud computing arrangement, 10s, 100s, or even 1000s of servers may be used. Further, the servers 108, 110, 112, and 114 may be virtual, i.e., servers implemented by software emulation. The servers 108, 110, 112, and 114 may include web servers, cloud servers, and other computing architectures that provide content to other servers or computing devices, such as, for example, a purchaser device 116 and a user device 118. In some embodiments, the servers 108 and 110 within the marketplace service 102 may function as a server for storefront services and a server for licensing services, respectively. Moreover, in embodiments disclosed herein, the term “purchaser device” may be used to denote any type of computing device operated by a particular “purchaser,” wherein the purchaser may be an administrator for a particular application license. Additionally, the term “user device” may be used to denote any type of computing device operated by a particular “user.”

The marketplace service 102, the client platform 104, and the third party service 106 may be coupled to each other through a network (not shown), wherein the network may include any type of network or combination of networks that provide access to the servers 108, 110, 112, and 114. In some embodiments, for example, the network may be a local area network (LAN), a wide area network (WAN), a wireless wide area network (WWAN), the Internet, or any combinations thereof. In addition, the marketplace service 102, the client platform 104, and the third party service 106, or any combinations thereof, may be colocated and physically coupled to each other.

The third party service 106 may provide services to an application running on the client platform 104. In various embodiments, the application code may run on top of the client platform 104 and may call the third party service 106. Alternatively, the application code may run on top of the client platform 104 without leveraging the third party service 106 at all. In both instances, the third party service 106 or the client platform 104, or both, may call the licensing service. Further, in some embodiments, the application may run on a separate device to the client platform 104, such as a personal computer or a mobile device. For example, the application may run on the purchaser device 116 or the user device 118, among others. Moreover the application may communicate with the client platform 104, as well as the third party service 106, through specific Web services.

The purchaser may log in to the client platform 104 by entering a username and password to authenticate against the client platform authentication service 119. The purchaser may then view a variety of applications that provide a number of different services to users. The purchaser device 116 may locate a desired application through the storefront 120, as indicated by an arrow 121. Moreover, in some embodiments, the purchaser device 116 may locate a desired bundle, wherein the bundle includes multiple related applications or other products. Once the purchaser has located the desired application, the purchaser may interact with the storefront 120 in the browser of the purchaser device 116 to begin the transaction. The purchaser device may then navigate from the storefront 120 to the marketplace authentication service 122 within the marketplace service 102, as indicated by the arrow 123. At this point, information is passed to the marketplace service 102 about the application the purchaser wishes to purchase (such as an application ID), the desired license (e.g., full, premium or trial) and the client platform's identity (such as a deployment identifier, or ID) and its location (such as a uniform resource locator, or URL, for the location of the client platform 102, which may be called a callback URL). In one embodiment, this information is passed as parameters in the URL from the storefront 120 to the marketplace service 102. The purchaser may then be prompted to sign in to the marketplace service 102 via the marketplace authentication service 122. In one embodiment, the marketplace authentication service 122 may use a different form of authentication than is used by the client platform authentication service 119. Moreover, in various embodiments, any of a number of authentication techniques may be used to authenticate the user, such as, for example, Windows NT authentication developed by Microsoft® Corporation, Windows Live ID Web Authentication developed by Microsoft® Corporation, Kerberos Authentication, or Form-Based Authentication. Additionally, in an embodiment, the marketplace authentication service 122 may operate within the server 108.

After log-in, the purchaser device 116 may buy a paid license for the desired application within the entitlement processing center 124, or may request a free trial license for the desired application. If the license is a paid license, it may have an associated level of entitlement, such as a premium paid license or a basic paid license, among others. In addition, paid licenses and trial licenses may each have a specific expiration date. Moreover, some free licenses may not have an expiration date but, rather, may allow a user unlimited access to specific services. After the entitlement has been processed by the entitlement processing center 124, information relating to the purchase, including information about the license for the application and information about the purchaser of the license, may be sent to an entitlement storage database 128, as indicated by an arrow 130. In some embodiments, the information about the purchaser of the license may include, for example, the purchaser's marketplace identity and an identifier for the client platform such as a deployment identifier (ID).

In addition, after the payment for the license has been processed, or the free trial license has been granted, a token for the license may be sent back to the purchaser device 116 through the storefront 120 within the client platform 104, as indicated by the arrow 132. In embodiments, the token may be referred to as an “entitlement token.” The marketplace service 102 may store the entitlement token in the entitlement storage database 128 or in a cloud-based store called an “entitlement store” (not shown), or both. The token may include a key ID that may be used to create a digital signature. The token may also include information relating to the date of the purchaser's last log-in to the marketplace service 102 and an expiration date for the token, such as, for example, thirty days after the token is issued. In some embodiments, the signature that is created using the key ID may be a hash-based message authentication code (HMAC). In some embodiments, the token may also contain encrypted information that can be decrypted by a particular Web service, such as the third party service 106, or a separate key provided to the developer of the token.

After the token has been generated within the marketplace service 102, the purchaser device 116 may be redirected to the storefront 120 within the client platform 104 by a callback URL having the embedded token. The callback URL may be passed to the client platform 104 from an application download repository service 133 within the marketplace service 102. In some embodiments, the token may be embedded within the URL. Once the purchaser's browser receives the token, as well as a product code for the application, the token and the product code may be read from the URL by the storefront 120 and then persisted locally in a centralized license storage database 134.

The purchaser device 116 may be allowed to assign a purchased number of seats for the license to users, wherein each license may have a different number of purchased seats. The purchaser device 116 may assign a seat to the user device 118, as well as to a number of additional user devices, through the seat assignment user interface (UI) 136 within the client platform 104, as indicated by the arrow 137. The seat assignments, or seat mapping, may then be stored within the centralized license storage database 134. Further, in some embodiments, the seats may be assigned based on the hardware signatures of particular user devices. Moreover, in some embodiments, a device other than the purchaser device 116 may be used to assign the seats to the users.

The centralized license storage database 134 may include information relating to the purchaser who is operating the purchaser device 116, wherein the purchaser may be designated as the administrator of the license. In an embodiment, all of the assigned user devices within the client platform 102, including the user device 118 and the purchaser device 116, may be authenticated using the same entitlement token. Moreover, once a particular user device 118 has been authenticated using the entitlement token, validation may be performed to verify that the user that is signed-in matches the user ID of the entitled user.

The user device 118 may install and attempt to access the particular application through an application center 138 within the client platform 104. In various embodiments, the application center 138 may be the place where the application code for the specific application runs inside the client platform 104. In addition, the user device 118 may also attempt to access the application directly through the third party service 106, as indicated by an arrow 139. In some embodiments, the user device 118 may attempt to access the application by entering a specific deployment ID relating to a specific entitlement token. At runtime, the application may call a token retrieval application programming interface (API) 140 within the client platform 104. The token retrieval API 140 may retrieve the entitlement token for the license for the particular application that the user device 118 is attempting to access. The token retrieval API 140 may then pass the entitlement token to the third party service 106 that powers the application. Specifically, the entitlement token may be passed to a licensing enforcing center 142 within the third party service 106, as indicated by the arrow 144.

The licensing enforcing center 142 within the third party service 106 may pass the received entitlement token to a token checker 146, or license verification center, within the marketplace service 102, as indicated by the arrow 148. In some embodiments, the token checker 146 may be stored within the server 110. The token checker 146 may verify the integrity of the entitlement token by checking the information relating to the token that is stored within the entitlement storage database 128, as indicated by the arrow 150. For example, the token checker 146 may check the integrity of the token using the HMAC signature. The token checker 146 may check the expiry date of the entitlement token and the expiry date of the license, and may audit the token in order to detect the fraudulent replaying of the same token. The token checker 146 may also verify that the license is still valid. Furthermore, in some embodiments, the client platform 104 itself may directly verify the validity of the entitlement token via the token checker 146.

Once the token checker 146 has decided whether the entitlement token is valid or invalid, the token checker 146 may send a message of valid or invalid back to the licensing enforcing center 142 within the third party service 106, as indicated by the arrow 148. The third party service 106 may then decide whether to allow the user device 118 to access the application based on the received message. The decision of the third party service 106 may be sent back to the application center 138, as indicated by the arrow 152. If the third party service 106 decides that the entitlement token is invalid, the user device 118 interfacing with the application center 138 may receive an error message indicating that access to the application has been denied, or, alternatively, the application may be allowed to run in a reduced-functionality mode. Otherwise, if the third party service 106 decides that the entitlement token is valid, the user device 118 may be allowed to access the resources of the application, which may be powered by the third party service 106.

In some embodiments, a licensing renewal center 154 within the marketplace service 102 may periodically communicate with a renewal job center 156 within the client platform 104, as indicated by the arrow 158. The licensing renewal center 154 may be stored within the server 110. If the token checker 146 determines that a particular license has expired, the license may be renewed within the licensing renewal center 154. In some embodiments, the token checker 146 may verify that a user's subscription is still valid before renewing the particular license. Moreover, the token checker 146 may determine that a license is desired for any reason, such as, for example, to include richer entitlement information or more secure encryption features. Thus, the license may be renewed within the licensing renewal center 154 at any time. Once a license has been renewed, the information relating to the new license, including a new entitlement token, may be sent to the renewal job center 156. However, if an expired license is not renewed, the token checker 146 may inform the third party service 106 that the entitlement token for the license is invalid.

FIG. 2 is a block diagram of a method 200 for application licensing authentication. A purchaser may access a marketplace service using a purchaser device by clicking on a link within the browser of the purchaser device. When the purchaser clicks on the link in the browser, they may transition to the marketplace service. For each transaction, there may be a unique deployment ID and a callback URL within the link. The purchaser may sign in to the marketplace service using their specific username or other form of identification, such as, for example, a purchaser ID. Moreover, in various embodiments, the purchaser may also sign in to the client platform prior to signing in to the marketplace service. At block 202, a request by a purchaser device for a license for an application may be processed at the marketplace service. For example, the purchaser may purchase a paid license or request a trial license for the desired application or service, wherein the application or service may be powered by a third party service. Moreover, in some embodiments, the purchaser may request a license for a number of applications, i.e., a bundle of applications. The entitlement for the transaction may be generated and stored within a cloud-based storage system, or entitlement store, within the marketplace service.

At block 204, a token may be sent from the marketplace service to the client platform. The token for the particular license may be generated by the marketplace service once the entitlement request has been processed. In some embodiments, the token may be referred to as an entitlement token. The entitlement token may include a variety of information regarding the license, including, for example, the application ID, the number of seats purchased (i.e., the number of users allowed to access the application), the deployment ID, and the purchaser ID. In some embodiments, the application ID may be an identifier for the application or service being purchased. The token may also include a key ID that may be used to create a signature based on HMAC signing, the date of the last sign-in to the marketplace service, and a start date or an expiration date of the token. In addition, the token may contain specific information about the particular type of license that was issued, such as, for example, a paid premium license, a paid standard license, or a trial license.

The marketplace service may send the token back to the purchaser device through the client platform using the callback URL. In some embodiments, the token may contain a digital signature for the plain text portion, wherein the digital signature may be in the form of an HMAC digest. The purchaser device may receive the token and the particular product code, or HTML page, and may send this information to a centralized licensing database within the client platform. In some embodiments, the client platform may verify the integrity of the token using the token checker before the token is imported into the licensing database. The centralized licensing database may also designate the purchaser as the administrator for the license and may allow the purchaser to assign seats, or specific users, for the license using the purchaser device. The number of seats which may be assigned is limited by the specific number of users which are allowed under the terms of the license. Within the client platform, the purchaser may have the same identity as the users in terms of license authentication. However, the purchaser and the users may not have the same identity within the marketplace service. Moreover, some of the users may not even have accounts or user IDs within the marketplace service. Further, in some embodiments, the purchaser may assign seats, or usage rights, based on the hardware identification of particular user devices, instead of based on specific users.

In some embodiments, when a particular user attempts to install the application under the license using a user device, the client platform may pass the entitlement token back to the marketplace service. The marketplace service may assume that the entitlement token is complex enough to prevent successful guessing of the token and, thus, may consider the token to be equivalent to user credentials. The application may then be downloaded from the marketplace service and installed on the user device. When the user attempts to access or run the application, however, the application may send the entitlement token to the third party service that powers the particular application. In order to verify that the user device is an approved user of the application, the third party service may pass the entitlement token to the marketplace service.

At block 206, the token may be accepted from the third party service at the marketplace service. At block 208, the validity of the token may be verified within the marketplace service. Within the marketplace service, a token checker may be used to verify the validity of the entitlement token. Integrity checking of the token may be performed using the HMAC signature. In addition, the expiry date of the token may be checked to ensure that the token is not outdated. In an embodiment, auditing of the token may also be performed in order to detect and prevent fraudulent replaying of the same token. The validity of the license may also be confirmed though a license verification center within the marketplace service. Furthermore, in some embodiments, the client platform itself may directly verify the validity of the entitlement token via the token checker.

At block 210, a message may be returned from the marketplace service to the third party service in order to verify the validity of the token. The marketplace service may send a valid message to the third party service if the token checker was able to confirm the validity of the token. The third party service may then decide whether to allow the user device to access the application.

If the third party service decides to allow the user device to access the application, specific levels of service within the application may then begin running on the user device, for example, through the client platform or on the user device. In various embodiments, the third party service may also provide an appropriate richness of services to power the application on the user device. For example, if the application being purchased is a visualization tool and if the token is for a paid license, the services powering the app may support producing rich, high-resolution, colourful visualisations. If the token is for a trial service, the services powering the app may support producing limited-scale, low-resolution, black-and-white visualisations.

It should be understood that the block diagram of the method 200 is not intended to indicate that the steps of the method 200 should be executed in any particular order or that all of the steps are to be included in every case. Further, steps may be added to the method 200 according to the specific application. For example, if the validity of the token is not verified at block 208, a message may be returned from the marketplace service to the third party service in order to deny the validity of the token at block 210. In addition, the third party service may deny the user device access to the application if the third party service decides that the token is invalid, or the third party service may allow the user device to run the application in a reduced-functionality mode. Furthermore, if the token is invalid, the services powering the app may not support producing any visualisations, or may offer the user a trial level of support.

Further, in some embodiments, the validity of the license for the application may be periodically verified, and the license may be renewed upon receiving another payment for the application from the purchaser through the purchaser device. The entitlement token may also be updated at specified time intervals to replace the old token with a new token. However, users may be allowed to access the new token using the old token for a specified period of time in order to prevent users from being locked out of the application. In some embodiments, a current entitlement token may be revoked if the purchaser signs in directly to the marketplace service. This may allow the purchaser to change the seat assignments for the license or to make any other desired changes to the conditions of the license.

In some embodiments, the method 200 may be used by a third party service to verify a user's entitlements to access a telephony service. The method 200 may also be used to verify a user's usage rights for storage applications or services. Furthermore, the method 200 may be used to verify a user's entitlements to in-game credits or resources for gaming applications or services. In various embodiments, the method 200 may be also utilized for the verification of entitlements to standalone services, which involve the use of a particular service independent of an application.

FIGS. 3A and 3B are an embodiment of a message flow diagram 300 for application licensing authentication in which the user does not have to sign in to the marketplace service 102 in order to utilize the application. Like numbered items are as described with respect to FIG. 1. A purchaser may be prompted to sign in to the marketplace service 102 through the entitlement processing center 124 or, in some embodiments, through the marketplace authentication service 122 (not shown) discussed with respect to FIG. 1. Once the purchaser has successfully signed in, the purchaser may send a payment for a paid license for an application to the entitlement processing center 124 from the purchaser device 116, or the purchaser may request a time-limited, free trial license for the application at the entitlement processing center 124. The purchaser may be prompted to select or enter the desired number of seats for the license, as well as an application ID. In some embodiments, the purchaser may also be prompted to enter a time period for pre-payments or subscription payments for the license. An entitlement for the license may be written at the entitlement storage database 128. In an embodiment, the entitlement may include an application ID, a purchaser ID, a number of seats purchased, or a deployment ID, among others. Moreover, an entitlement token may be also generated for the particular license within the entitlement processing center 124.

Once the entitlement token has been generated at the entitlement processing center 124, the token may be passed to the purchaser device 116 through the client platform 104. In various embodiments, the token may be passed by calling back to a callback URL containing the token. The purchaser device 116 may then initiate a download of the application by passing the entitlement token back to the entitlement processing center 124 within the marketplace service 102. The entitlement processing center 124 may verify the token signature and the state of the application, and may send the verification information to the entitlement storage database 128. In addition, the entitlement may be verified by the entitlement storage database 128. A sign-in date stamp may be generated in order to record the purchaser's log-in information.

Verification of the entitlement may be sent back to the entitlement processing center 124. Once the entitlement processing center 124 receives verification of the entitlement, the entitlement processing center 124 may call on the application download repository service 133 to return the callback URL to the entitlement processing center 124. The entitlement processing center 124 may then call back the URL to the storefront 120 (not shown) running in the browser of the purchaser device 116. Moreover, once the application download repository service 133 receives verification of the entitlement, the service 133 may commence the download of the application. In some embodiments, this immediately commences the download of the binary application. In other embodiments, a temporary URL to that application is returned, and the client platform accesses this URL to download the application.

The storefront 120 running in the browser of the purchaser device 116 may request the metadata relating to the desired application from the entitlement processing center 124 within the marketplace service 102. Such metadata may include an icon, title, or name of the application. The entitlement processing center 124 may send the requested metadata to the purchaser device 116 and may prompt the purchaser device 116 to assign the seats for the license. The purchaser device 116, or any other device that may be accessed by the purchaser of the license, may then assign each of a specific number of seats to particular users within the client platform 104. The purchaser device 116 may write the data relating to the license, such as the application ID and the entitlement token, as well as the icon, title, and description of the application, to the license storage database 134 within the client platform 104. In addition, the purchaser device 116 may also write the list of assigned users for the particular license to the license storage database 134.

A user may attempt to access the application under the license through the user device 118. The application running on the user device 118 may request the entitlement token from the license storage database 134 within the client platform. The license storage database 134 may then return the entitlement token to the user device 118 if the application is being run by the user device 118 itself or to a specific browser if the application is being accessed by the user device 118 through the browser. The application may then begin to load on the user device 118. In an embodiment, the user device 118 may directly access the third party service 106 that powers the specific application to allow the user device 118 to run the application, without necessarily going through the application center 138.

Before deciding whether to allow the user device 118 to access the application, the third party service 106 may perform an initial evaluation to verify that the number of concurrent users does not exceed the seat count for the license. If this condition is met, the third party Web service 106 may send the entitlement token to the token checker 146. The token checker 146 may perform an evaluation procedure to determine whether the token is valid or invalid and may notify the third party service 106 of the result of the evaluation. If the entitlement token is determined to be valid, the entitlement may be cached for the session of the user device 118. In addition, if the entitlement token is determined to be valid, the third party service 106 may then allow the user device 118 to start the application. However, if the entitlement token is determined to be invalid, the third party service 106 may deny the user device 118 access to the application.

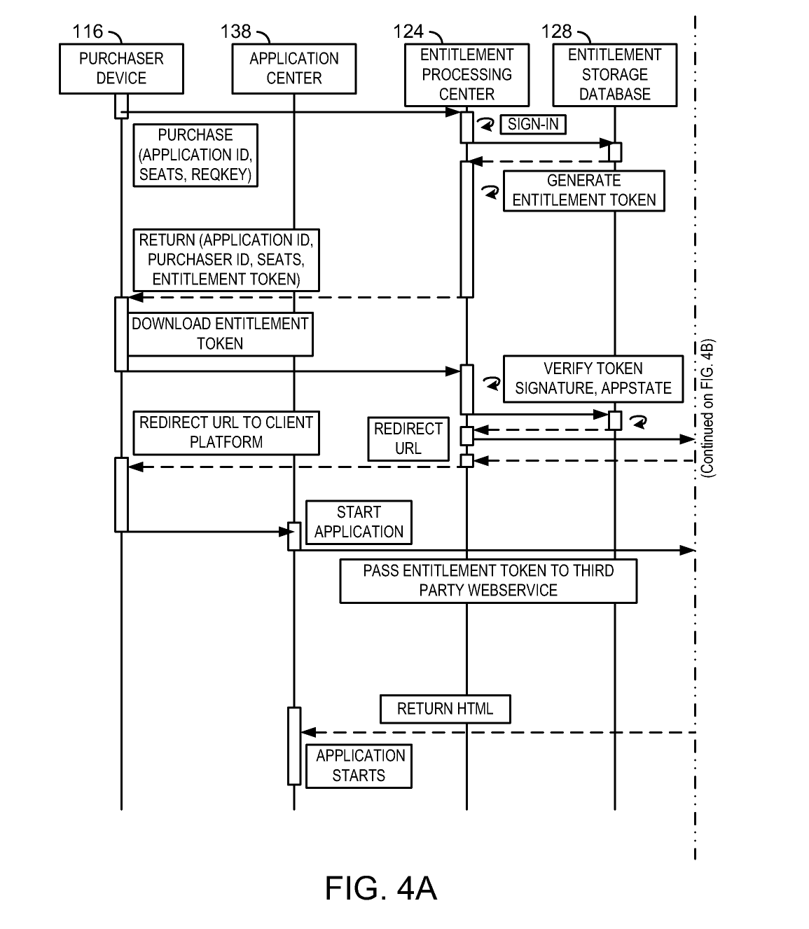

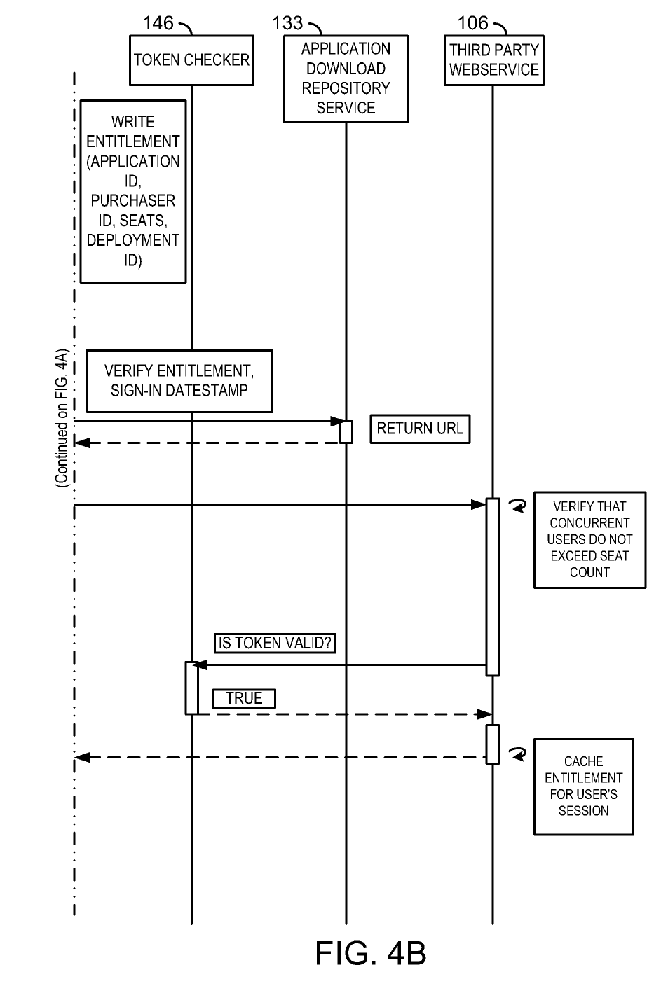

FIGS. 4A and 4B are an embodiment of a message flow diagram 400 for application licensing in which the purchaser is also the user. Like numbered items are as described with respect to FIG. 1. In this embodiment, a user device 118 (FIG. 1) is accessing the application through the application center 138. A purchaser may utilize a purchaser device 116 to buy a license for an application through the entitlement processing center 124 within the marketplace service 102 in the same manner as that discussed with respect to FIGS. 3A and 3B. In addition, the generation and downloading of the entitlement token, the verification of the token signature and the entitlement, and the return of the entitlement token to the purchaser device 116 may be performed in the same manner as that discussed with respect to FIGS. 3A and 3B.

However, instead of assigning seats to users and allowing a user to access the application from the user device 118, as described with respect to FIGS. 3A and 3B, the purchaser, or another user, may access the application through the application center 138. Accordingly, the purchaser device 116 may attempt to load the application through the application center 138. At this point, the entitlement token may be passed to the third party service 106. The third party service 106 may verify that the number of concurrent users does not exceed the seat count. If this condition is met, the third party service 106 may send the entitlement token to the token checker 146. The token checker 146 may perform an evaluation procedure to determine whether the token is valid or invalid and may notify the third party service 106 of the result of the evaluation. Moreover, in some embodiments, the third party service 106 may determine whether the particular user is authorized to use the entitlement token based on specific user ID information that was separately provided to the third party service 106. If the entitlement token is determined to be valid, the entitlement may be cached for the session of the purchaser device 116. In addition, if the entitlement token is determined to be valid, the third party service 106 may then allow the purchaser device 116 to start the application through the application center 138. However, if the entitlement token is determined to be invalid, the third party service 106 may deny the purchaser device 116 access to the application.

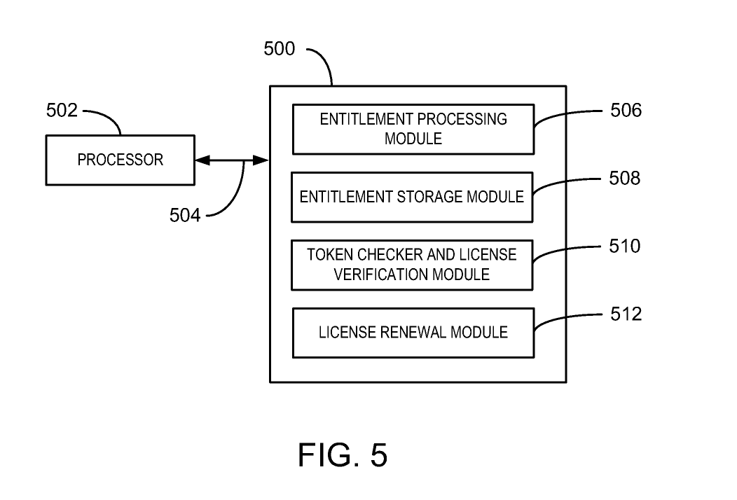

FIG. 5 is a block diagram showing a tangible, computer-readable medium 500 that stores code adapted to authenticate a license for an application that is powered by a third party service. The tangible, computer-readable medium 500 may be accessed by a processor 502 over a computer bus 504. Furthermore, the tangible, computer-readable medium 500 may include code configured to direct the processor 502 to perform the steps of the current method.

The various software components discussed herein may be stored on the tangible, computer-readable medium 500, as indicated in FIG. 5. For example, an entitlement processing module 506 may be configured to process a payment for a paid license from the purchaser device, or to grant a free trial license for a particular application, and to send an entitlement token back to the purchaser device. An entitlement storage module 508 may be configured to store information relating to the particular license, including, for example, the number of purchased seats, the application ID, the deployment ID, or the purchaser ID, or any combinations thereof. A token checker and license verification module 510 may be configured to verify the integrity of the entitlement token and the license to ensure that they are valid and have not expired. In addition, a license renewal module 512 may be configured to renew an expired license upon receipt of additional payment from the purchaser device through the client platform.

It should be noted that the block diagram of FIG. 5 is not intended to indicate that the tangible, computer-readable medium 500 always include all the software components 506, 508, 510, and 512. In addition, the tangible, computer-readable medium 500 may include additional software components not shown in FIG. 5. For example, the tangible, computer-readable medium 500 may also include an application download repository module configured to store a callback URL for a particular license, as well as information pertaining to the license.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for application licensing authentication, comprising:
processing a request for a license for an application from a purchaser at a marketplace service;
sending a token from the marketplace service to a client platform, wherein the client platform is configured to allow the purchaser to assign a seat to a user and to send the token to a third party service when the user attempts to access the application;
accepting the token from the third party service at the marketplace service;
verifying a validity of the token within the marketplace service; and
returning a message verifying the validity of the token to the third party service, wherein the third party service is configured to allow the user to access specific levels of service within the application through the client platform.

2. The method of claim 1, comprising sending the token from the marketplace service to the client platform via a callback URL.

3. The method of claim 1, comprising updating the token at specified time intervals to replace an expired token with a new token.

4. The method of claim 1, wherein processing the request for the license for the application comprises processing a sign-in of the purchaser at the marketplace service, wherein the purchaser previously signed-in to the client platform.

5. The method of claim 1, wherein processing the request for the license for the application comprises accepting a deployment identifier and a callback URL from the purchaser through the client platform.

6. The method of claim 1, comprising revoking the validity of the token if the purchaser signs in to the marketplace service through the client platform.

7. The method of claim 1, comprising returning an invalid message to the third party service if the validity of the token cannot be verified, wherein the third party service is configured to deny the user access to the specific levels of service within the application.

8. The method of claim 1, comprising allowing the user to access a reduced-functionality mode of the application if the validity of the token cannot be verified.

9. The method of claim 1, wherein sending the token from the marketplace service to the client platform comprises sending a key identification, a date of a last sign-in to the marketplace service, an expiry date of the token, or a signature, or any combinations thereof.

10. A system for application licensing authentication within a marketplace environment, wherein the system comprises a marketplace service configured to:
accept a request for a license for an application within a client platform from a purchaser;
send a token from the marketplace service to the client platform, wherein the client platform is configured to allow the purchaser to assign a seat to a user and to send the token to a third party service when the user attempts to access the application;
accept the token from the third party service;
verify a validity of the token; and
return a message verifying the validity of the token to the third party service, wherein the third party service is configured to allow the user to access services within the application through the client platform.

11. The system of claim 10, wherein the client platform is configured to allow the purchaser to assign a seat to each of a plurality of users.

12. The system of claim 10, wherein the token comprises an entitlement token that is stored in an entitlement store within the marketplace service.

13. The system of claim 10, wherein the token comprises a key identification, a date of a last sign-in to the marketplace service, an expiry date of the token, or a signature, or any combinations thereof.

14. The system of claim 10, wherein the license for the application comprises a paid license or a trial license.

15. The system of claim 10, wherein verifying the validity of the token comprises using a token checker.

16. The system of claim 10, wherein the third party service is configured to deny the user access to the application if the validity of the token cannot be verified by the marketplace service.

17. One or more non-volatile computer-readable storage media for storing computer readable instructions, the computer-readable instructions providing an application licensing authentication system when executed by one or more processing devices, the computer-readable instructions comprising code configured to:
process a request for a license for an application from a purchaser at a marketplace service;
send a token from the marketplace service to a client platform, wherein the client platform is configured to allow the purchaser to assign a seat to a user and to send the token to a third party service when the user attempts to access the application;
accept the token from the third party service;
verify a validity of the token; and
send a message verifying the validity of the token to the third party service, wherein the third party service is configured to allow the user to access different levels of service within the application.

18. The one or more computer-readable storage media of claim 17, wherein the user accesses the different levels of service within the application via a user device.

19. The one or more computer-readable storage media of claim 17, wherein the third party service comprises an application center.

20. The one or more computer-readable storage media of claim 17, the computer-readable instructions comprising code configured to revoke the validity of the token if the purchaser signs in directly to the marketplace service through the client platform.
